(19) United States
(12) Patent Application Publication
(10) Pub. No.: US 2010/0094891 A1
(43) Pub. Date: Apr. 15, 2010

(54) Client-Server System for Multi-Resource Searching

(75) Inventors: Timothy J. Noyes, Centreville, VA (US); Dickerson S. Sanders, Occoquan, VA (US)

Correspondence Address: PATENTBEST, 4600 ADELINE ST., #101, EMERYVILLE, CA, 94608, US

(73) Assignee: BID SOLVE, INC., Manassas, VA (US)

(21) Appl. No.: 12/491,947

(22) Filed: Jun. 25, 2009

Related U.S. Application Data
(60) Provisional application No. 61/104,788, filed on Oct. 13, 2008.

(51) Int. Cl. G06F 17/30

(52) U.S. Cl. 707/759; 707/E17.136; 707/E17.032

(57) ABSTRACT

Systems and methods for searching multiple resources via a communications network, such as the Internet, are disclosed. The systems use a client-server approach in which search clients formulate search requests for a plurality of resources in a generalized format. The search requests are sent to a server, and specific uniform resource locators (URLs) for the desired resources and search terms are returned to the clients. The clients display the search results grouped by category and by resource, for example, with two sets of tabs. Each set of results is rendered using a browser engine, and the set is generally presented in its entirety. The server may define the resources available to the clients for search, and may also provide promotional information with the search results. Particular resources and features may be made available to particular groups and users.

### CROSS-REFERENCE TO RELATED APPLICATIONS

This application claims priority to, and the benefit of, U.S. Provisional Patent Application No. 61/104,788, filed Oct. 13, 2008, the contents of which are incorporated by reference herein in their entirety.

### BACKGROUND OF THE INVENTION

1. Field of the Invention

The invention relates generally to the field of computerized searching, and more particularly to client-server systems for multi-resource searching.

2. Description of Related Art

The Internet and its World Wide Web have become ubiquitous and vital tools for modern commerce. Almost every modern company has some form of website. Meanwhile, the Web itself has become a vast repository of information, and a major source for shopping and entertainment.

The trouble with the World Wide Web lies in finding the desired resources. General search engines, like Google, Yahoo!, and Ask.com, allow users to find Web sites and information. Major online sellers like Amazon.com and EBay allow users to find products of various sorts. Other sites allow users to search for other things. Each of these sites is powerful and useful for its own purpose, but the number of search sites, and the number of retailers, has grown to the point at which searching itself becomes a chore, and finding the right search site, or the right retailer for a particular product, is difficult.

There have been some attempts over a number of years to provide “multi-search” capabilities, which allow a user to search multiple sites or other Internet resources from a single location. Many of these programs have taken the form of a single client application designed to run on a user's computer system. The client application has “plug-ins” that allow it to run queries on various World Wide Web sites and to use various other Internet resources. Using those plug-ins, the results from the various queries and searches are formatted for the client application and returned to it. SHERLOCK, a program made and distributed by Apple, Inc. (Cupertino, Calif., United States) is one example of such a program.

There are several disadvantages to this traditional sort of multi-search application. First, because the query results and sites or resources are often formatted in a very particular way for the multi-search application, the search results are not generally rendered as they would be if they were accessed in a Web browser, and the user may not have the ability to browse the results as he or she would in a Web browser. Additionally, most of these applications tend to become useless over time as Web sites are updated. This is because Web sites are dynamic, and the types of queries that can be run, and the syntax for initiating those queries, may change over time. As the query language and syntax changes, the multi-search application may not have the correct language and syntax to perform queries on the updated sites, rendering it essentially useless.

### SUMMARY OF THE INVENTION

Aspects of the invention relate to systems and methods for allowing a user to search multiple resources over a computer network, such as the Internet. The systems use a client-server approach in which clients accept search requests or queries and send those requests to a server, which provides the clients with specific resource locators corresponding to the search requests. The clients then retrieve the search results using the specific resource locators, and generally display the search results in their entirety using an interface with full browser functionality. In some embodiments, the server may also search for promotions related to the search requests or the resources selected for the search and may return to the clients modified or altered resource locators that cause the clients to retrieve the search results and at least an indication of the associated promotions.

One particular aspect of the invention relates to a client interface for use in a multi-resource searching system. The client interface comprises a search form that allows a user to enter search requests and to select one or more resources on which that search is to be carried out. The interface then presents the results grouped by category and by resource. For example, the interface may provide a first set of grouping elements, such as tabs, for the category, and a second set of grouping elements, such as another set of tabs, under each category, one for each of the selected resources. The interface presents the search results from each resource with full browser functionality, e.g., by showing the results inside a browser window.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the drawing figures, and in which:

FIG. 1 is a schematic illustration of a system according to one embodiment of the invention;

FIG. 2 is a flow diagram of a method for processing a query using the system of FIG. 1;

FIG. 3 is an illustration of a client-side interface for use in the clients of the system of FIG. 1 in a minimized state;

FIG. 4 is an illustration of the client-side interface of FIG. 3 in a maximized state after a single search has been performed using a single resource;

FIG. 5 is an illustration of the client-side interface of FIG. 4 in a maximized state after multiple searches have been performed using multiple resources;

FIG. 6 is a flow diagram of a method of generating queries and displaying search results using the system of FIG. 1;

FIG. 7 is an illustration of the client-side interface of FIG. 3, showing the display of a special offer related to a resource; and

FIG. 8 is a functional illustration of a server according to another embodiment of the invention.

### DETAILED DESCRIPTION

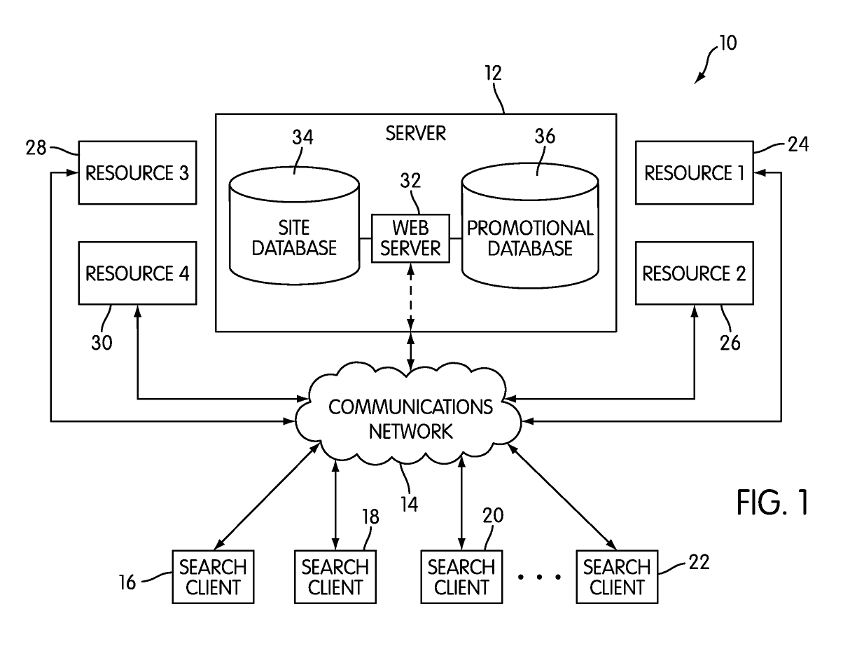

FIG. 1 is a schematic illustration of a system according to one embodiment of the invention, generally indicated at 10. System 10 is a distributed, client-server system for multi-resource searching. In system 10, a server 12 is coupled to a communications network 14, such as the Internet, and is connected to one or more search clients 16, 18, 20, 22 through the communications network 14. Search queries from the search clients 16, 18, 20, 22 are sent to the server 12 in a generalized format, which looks up the resources necessary to perform the search and the search language or syntax necessary for using each resource and, using the communications network 14, returns to the clients 16, 18, 20, 22 one or more search redirects or resource locators to allow the search clients 16, 18, 20, 22 to communicate directly with the various search resources 24, 26, 28, 30 using the communications network 14.

Most advantageously, the system 10 and server 12 allow the search clients 16, 18, 20, 22 to perform a “multi-search,” i.e., perform the same search essentially simultaneously on multiple search resources 24, 26, 28, 30 after entering a single query that is then formatted by the server 12 for each of the search resources 24, 26, 28, 30. As will be described below in greater detail, in particularly advantageous embodiments of the invention, each of the search clients 16, 18, 20, 22 allows the user to review and browse the search results using a convenient, integrated interface.

As the term is used here, a “search resource” refers to any Web or network site, service, server, or other information provider that has information, products, listings, or other offerings that a user might want. Search resources may include Web search engines (e.g., Google, Yahoo!, etc.), online and physical retailers (e.g., Amazon.com, Best Buy, eBay, etc.), news providers (The New York Times, The Washington Post, CNN, MSNBC, the Associated Press, etc.), travel information and booking providers (e.g., Expedia, Priceline.com, Kayak.com, etc.), sports information providers, medical information providers, shippers (e.g., FedEx, UPS, the U.S. Postal Service), and any other web site or service that provides information over the Internet. The resources need not be external commercial providers; instead, at least some of the resources may be company intranets, internal company databases, or files and file listings.

It should also be understood that the server 12, although referred to in the singular here for simplicity and clarity, may be a single machine or any number of machines that are configured to operate or handle requests together. If the server 12 is implemented as a group of interoperating machines, that group of machines may or may not be configured to appear as a single logical machine to the other elements of system 10. The server 12 may be a general or special purpose computer equipped with, for example, conventional server software allowing it to communicate with the search clients 16, 18, 20, 22 over the communications network 14 and database software allowing it to store and retrieve information.

In one embodiment, the server 12 includes a web server 32 that accepts requests, for example, hypertext transfer protocol (HTTP) requests, from the search clients 16, 18, 20, 22 through the communications network 14. Those requests may, for example, be conveyed from the search clients 16, 18, 20, 22 through the communications network 14 using the well-known transmission control protocol/internet protocol (TCP/IP). However, it should be noted that although the Internet and World Wide Web may be used, the communications network 14 need not necessarily be the Internet. Intranets of various types and other communications protocols may be used, and the resources 24, 26, 28, 30 may be nodes or servers on that network.

As one example, the web server 32 may comprise conventional web server software, such as Apache web server software (the Apache Software Foundation, Forest Hill, Md., United States), running on the server. The web server 32 would generally also have the capability to generate responses to requests dynamically, based on the nature of the requests. Thus, in addition to Web server software, the web server 32 may also be equipped with any number of server-side scripting or preprocessing languages, such as PHP and Perl, compiled languages, such as C and C++, and any other languages or processing capabilities typically found in a Web server. The web server 32 may be implemented on the same physical machine on which the other server components are running, or it may be implemented on a separate machine. In either case, firewalls or other access control and security restrictions may be implemented to isolate the web server 32 and its functions partially or completely from any other programs or functions that the server 32 performs.

The server 12 generally also provides at least two databases, a resource database 34 and a promotional database 36. For clarity and convenience in description, these two databases will be described as being separate, although they may be implemented together, for example, as two distinct tables within the same database, or even using a single table. These databases would generally constructed using a database program that implements a query language, such as structured query language (SQL). Any known database program may be used to implement the databases 34, 36. One example of a suitable database program is MySQL (MySQL, Inc., Cupertino, Calif., United States).

The resource database 34 contains information used to translate queries from the search clients 16, 18, 20, 22 into uniform resource locators (URLs) or uniform resource indicators (URIs) that are returned to the search clients 16, 18, 20, 22 so that the search clients can contact the resources 24, 26, 28, 30 directly. More generally, the resource database 34 may contain any information needed to translate a query from one of the search clients 16, 18, 20, 22 into a search or request for information that can be executed by one of the resources 24, 26, 28, 30.

The fields and data stored in the resource database 34 will vary from embodiment to embodiment depending on the particular resources 24, 26, 28, 30, and will also depend on the data that is communicated to each resource 24, 26, 28, 30 and the syntax used to communicate that data. More particularly, in order to initiate a search or query, most resources 24, 26, 28, 30 require or expect that in addition to the query terms or query string, certain other search-relevant information will be provided. That other search relevant information may include, for example, the country from which the query is being made, the language of the query and/or the language expected in the results or reply, the character set, and the identity and nature of the application from which the query originated. Some resources 24, 26, 28, 30 may also allow the query to specify that the query comes from a particular referrer or affiliate, and will reward the referrer or affiliate for sending the user to the resource 24, 26, 28, 30. Of course, a resource 24, 26, 28, 30 typically accepts the query terms or string and initiates the search only when the information is presented using a particular syntax. As was noted briefly above, that syntax is typically different for each resource 24, 26, 28, 30 and may vary over time.

For example, assume that a user wishes to search for the terms “fat dog” on the World Wide Web using one or two common search engines. Typically, the user would go to the Web site of the search engine and would enter the search terms of interest in the appropriate field of a form on a Web page. When the user then pressed the graphical or textual button to “submit” the search to the search engine, a script downloaded with the Web page and running on the user's Web browser, or the Web browser itself, would translate the search or query terms into a URL or URI with arguments using the appropriate syntax. Using Ask.com, one of the common World Wide Web search engines at the time of writing, the search URL might be similar to: http://www.ask.com/web?q=fat+dog&search=search&qsrc=0&o=0&l=dir

In that URL, the search terms fat dog (“q=fat+dog”) are presented, as are a number of site-specific search-relevant information, including the fact that the search is to be performed on the World Wide Web in general. However, if the same search is performed using the Google search engine, another common World Wide Web search engine, the URL might be similar to: http://www.google.com/search?hl=en&q=fat+dog&btnG=Google+Search&aq=f&oq=
That string, among other things, specifies the search terms, the language of the search, and a number of other site-specific elements.

If a user is accessing a search engine or other resource from a Web browser, knowing the correct syntax for forming URLs and initiating queries using that resource is not a problem, because the browser downloads an updated Web page with the correct forms or scripts each time the resource's Web site is accessed. However, knowing the correct syntax does become an issue if a user is not accessing a resource's Web page prior to submitting a query, as is often the case with system 10. The resource database 34 of the server 12 allows the server 12 to translate a query from a client 16, 18, 20, 22 into a URL with syntax appropriate for a particular resource 24, 26, 28, 30, such that the client 16, 18, 20, 22 is not generally required to have any particular information on the syntax for any particular resource 24, 26, 28, 30. Typically, the resource database 34 would be kept up-to-date by the operator of the server 12, such that search clients 16, 18, 20, 22 always have available to them the correct URLs and syntax used to communicate with and query the search resources 24, 26, 28, 30. Thus, as long as the resource database 34 is maintained, the clients 16, 18, 20, 22 will not go “stale” or lose the ability to query certain resources 24, 26, 28, 30.

The promotional database 36, which may not be included in all embodiments, stores information on special relationships and promotions relating to the resources 24, 26, 28, 30. It may also store messages that are to be passed to the clients 24, 26, 28, 30 when a search of a particular resource 24, 26, 28, 30 is initiated. For example, the server operator or other authority may negotiate a “deal” for users in which users of system 10 save 10% or 20% on particular merchandise when it is purchased through a search client 16, 18, 20, 22 as a part of system 10. Therefore, if a user performs a search and a search of the promotional database 36 indicates that a promotion is connected with the search, information on the promotion may be presented with the search results. For example, if there is a “coupon” for a discount, the server 12 may provide that coupon to the particular client 16, 18, 20, 22. Methods for performing this task will be described below in more detail.

One advantage to client-server distributed systems like system 10 is that the user or requesting client 16, 18, 20, 22 need not be presented merely with a list of search results that correspond to a query. Instead, the server 12 may filter and rank the search results in any known manner, and may also push out search results that, while not directly responsive to the query, appear to be related. For example, if a user has directed a search of electronics retailers A, B, and C for a particular product, it may be desirable to present information or pricing on that product from electronics retailer D, and further, to present the results from retailer D first or preferentially as compared with the results from the other retailers. To that end, the promotional database 36, or another database maintained on or in communication with the server 12 may contain information on particular resources 24, 26, 28, 30 that are to be queried and promoted for particular types of queries, or on the order in which information from multiple resources 24, 26, 28, 30. As will be described in more detail below, the server 12 may also communicate with the search clients 16, 18, 20, 22 to define which resources 24, 26, 28, 30 can be accessed or queried using the clients 16, 18, 20, 22.

Of course, information from the user or the client 16, 18, 20, 22 may be necessary or desirable in performing a query. For example, if the query relates to the weather, it is generally necessary to know for what geographic area the user wishes to know the weather. Additionally, searches for maps and directions generally require a starting address, and other types of searches may require myriad types of personal information (e.g., account information, passwords, credit card or other payment information, etc.). As will be described below in more detail, the search clients 16, 18, 20, 22 may collect and store user-specific, site-specific, or other particular information necessary or desirable for performing various types of queries, and may provide that information to the server 12 in the course of initiating a query.

The description of the relationship between the elements of system 10 presented above is not intended to be exclusive. In particular the functions of and relationships between the various components may shift slightly. This may depend on the computing power of and functionality available on the clients 16, 18, 20, 22, with more capable clients 16, 18, 20, 22 performing more tasks or “pre-processing” prior to sending a query to the server 12.

As another example, in some embodiments, the clients 16, 18, 20, 22, may be provided with some form of resource database, either as a backup for the server's resource database 34 or to provide each of the clients with an indication of the information necessary to communicate to the server 12 in the process of initiating a query and forming a URL. If a client 16, 18, 20, 22 has a resource database of its own, it may not need to communicate with the server 12 for every search; instead, the necessary information may be drawn from the local database. A client-side or local resource database or library may also indicate what local or user-specific information should be transmitted along with the query terms or search request. For example, a local resource database may indicate that for a query involving the weather, the client 16, 18, 20, 22 should transmit location information, like the ZIP or postal code, to the server 12. Alternately, the location of a client 16, 18, 20, 22 may be established on the server side by examining the client's IP address, search history and patterns, and any other information known.

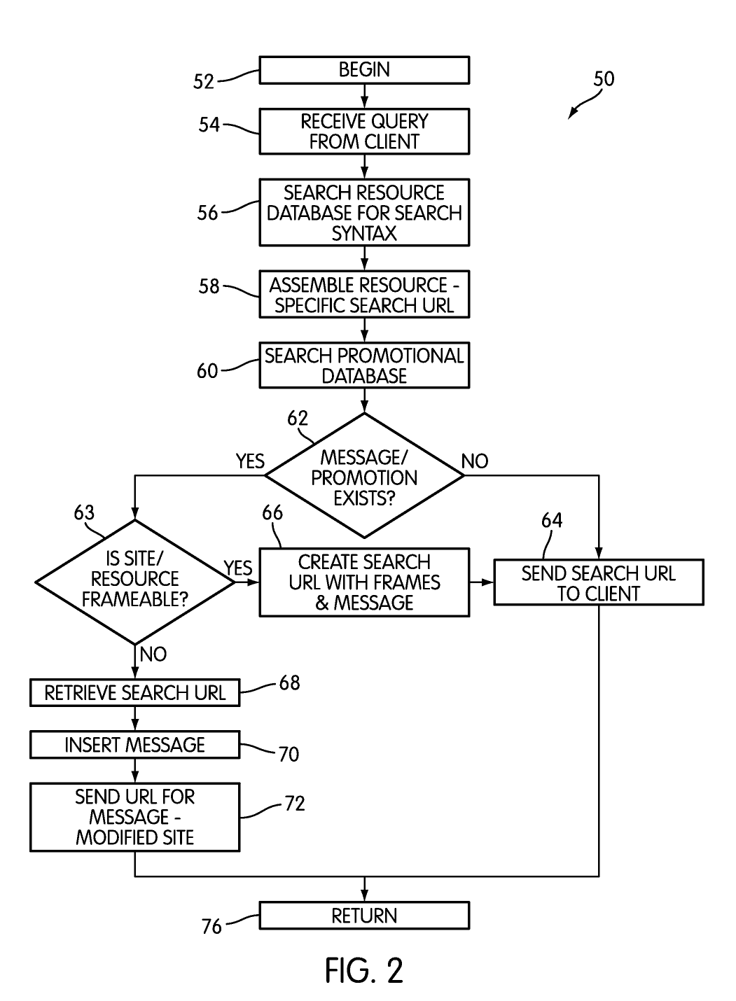

FIG. 2 is a flow diagram of a method, generally indicated at 50, for processing a single query from a client 16, 18, 20, 22 on the server 12. Method 50 begins at 52 and continues with task 54, when a query is received from a client 16, 18, 20, 22. That query will typically include the query or search terms, the resource 24, 26, 28, 30 that is to be searched, and any information needed from the client side, like location information, that may be needed in order to perform the search.

In the following description of method 50, it will be assumed that the query submitted by the client 16, 18, 20, 22 is a query involving accessing a single resource 24, 26, 28, 30 to search a single set of query terms. However, as was noted above, embodiments of the invention may advantageously allow a user to perform multiple, essentially simultaneous searches. That may be done by sending single queries to the server 12 in rapid succession. Alternatively, in some embodiments, a single query from a client 16, 18, 20, 22 may concatenate several different queries. For example, a concatenated query may request searches of the same query terms on several different resources 16, 18, 20, 22 or may request different search terms on different resources 16, 18, 20, 22. If concatenated search queries are permitted, task 54 may also involve the step of separating the concatenated request from the client 16, 18, 20, 22 into individual queries (i.e., one set of terms on one resource 24, 26, 28, 30), and the remaining tasks of method 50 could be executed in series or parallel to address each of the de-concatenated individual queries in turn. The resulting URLs may be concatenated for transmission back to the requesting client 16, 18, 20, 22 or not, depending on the embodiment.

Method 50 continues with task 56, in which the resource database 34 is searched for the correct syntax to use for the particular resource 24, 26, 28, 30 requested by the client 16, 18, 20, 22. If the resource database 34 is implemented as a SQL table or database, this task typically involves translating the query received by the server 12 in task 34 into a SQL query. For example, continuing with the example above of a search for the terms “fat dog,” assume that the server was accessed using the following URL, which represents a request for query language for a specific resource:

http://www.server.com/cgi-bin/searchdesk.php?engine=Ask&searchit=fat+dog (1)

in which “server.com” is the domain name of the web server 32, and the query URL causes the server 12 to execute a PHP script called “searchdesk.php,” giving that script arguments indicating that a search is to be performed on Ask.com for the search terms “fat dog.”

If the above query was received, the PHP script called by the query URL would execute, translating the arguments provided in the URL into a SQL query and performing the rest of the tasks described as being a part of method 50. For example, the above might result in a SQL query structured as:

SELECT * FROM search_parts WHERE id=‘Ask’
which would then be executed in the resource database 34 in order to find the proper syntax to search those terms using the specified resource. Method 50 would then continue with task 58.

In task 58, the server 12 would take the result of the SQL query made in task 56 and assemble the resource-specific URL. Generally, that entails inserting the specific query or search terms into the generalized search syntax retrieved from the resource database 34. The final resource-specific URL may include any of the kinds of other search-relevant information described above, including the identity of the server 12 as an affiliate or referrer.

Method 50 continues with task 60, in which the promotional database 36 is searched to determine whether there are any messages or promotions associated with the particular search resource 24, 26, 28, 30 or with the particular query terms. That task would generally involve one or more queries to the promotional database on the resource name and optionally on the query terms. Method 50 continues with task 62, a decision task.

In task 62, if there is no message or promotion associated with a particular search or a particular resource 24, 26, 28, 30 (task 62:NO), method 50 continues with task 64, in which the resource-specific search URL assembled in task 58 is returned to the requesting client 16, 18, 20, 22. However, if there is a message or promotion, method 50 continues with a series of tasks in which the server 12 arranges to provide that message or promotion to the requesting client 16, 18, 20, 22 so that it can be displayed to the user.

One of the easiest ways to present a promotion or message to the user is to leave the content of the site or resource 24, 26, 28, 30 unchanged and provide the promotion or message in a frame above, to the left, to the right, or at some other designated position relative to the unchanged content. Using HTML and the World Wide Web, this can be done by creating a frameset in which the content of the site or resource 24, 26, 28, 30 becomes the content of the largest frame, while a smaller frame is provided above, to the left, to the right, or in some other position relative to the main frame. These techniques are well-known to those of skill in the art. However, as is also known, some content on the Web can be readily framed while other content cannot be framed as easily. Thus, if a message or promotion does exist (task 62:YES), method 50 continues with task 64, another decision task in which it is decided whether or not the requested site or resource 24, 26, 28, 30 can be framed. This may be done by maintaining a database, table, or list of resources 24, 26, 28, 30 that cannot be framed and checking the requested resource 24, 26, 28, 30 against that list.

If the requested resource 24, 26, 28, 30 is frameable (task 64:YES), method 50 continues with task 66, in which the server 12 constructs an HTML frameset with the content and the promotion. The URL for that frameset—which includes the resource-specific search URL assembled in task 58, is then sent to the requesting client 16, 18, 20, 22 in task 64. The final frameset may have invisible barriers, so that the message or promotion appears to be essentially integrated into the content.

If the requested resource 24, 26, 28, 30 is not frameable (task 64:NO), then the site or resource is retrieved by the web server 32 or another portion of the server 12 in task 68, and the HTML or other descriptive language code for the message or promotion is directly inserted into the code that defines the site or resource in task 70 before the requesting client is sent a URL for the modified site or resource in task 72. After task 64 or task 72, method 50 completes and returns at task 76.

In the above, HTML framesets are described as being used to display messages or promotions in method 50. However, any technology or technique that allows content from one of the resources 24, 26, 28, 30 to be presented essentially undisturbed along with a message or promotion may also be used in method 50.

The description above focuses on embodiments in which the server 12 takes a search request from a client 16, 18, 20, 22 and returns a URL to the client, allowing the client to retrieve the search results. However, in some embodiments, it may be desirable for the server 12 to return actual content, instead of a URL. This could be done in essentially the same way as it is in tasks 68-72 of method 50. Returning actual content may be useful in promotional and a number of other situations.

Additionally, as those of skill in the art will realize, the URLs provided by the server 12 in method 50 for a particular resource need not be direct URLs. For example, in some embodiments, the client 16, 18, 20, 22 may request that search results be translated into a particular language. In that case, the server 12 may assemble a resource-specific search URL, and then use that URL as input to a translation engine or program, returning to the client 16, 18, 20, 22 a URL that points to the translated search. Alternately, it may be more convenient for the server 12 execute the requested search to retrieve the foreign-language search results, send those results to a local or remote translation engine or an external machine-translation resource, and return to the client 16, 18, 20, 22 the actual translated content, or a URL to the actual translated content as stored on the server 12.

### The Search Clients

As was described above, in system 10, a number of search clients 16, 18, 20, 22, each presumably owned and/or operated by a user, allow users to make queries using the system 10. Clients 16, 18, 20, 22 may vary in nature, form, properties, and capabilities from embodiment to embodiment. They may be implemented in hardware, software, or a combination of hardware and software. Additionally, clients according to embodiments of the invention could be implemented on a single machine or on multiple machines.

In one embodiment, for example, a client could be implemented as a software application that runs on a single, general-purpose computer system. Typically, the computer system would have some sort of operating system, for example Microsoft Windows XP or VISTA (Microsoft Corporation, Redmond, Wash., US) or Macintosh OS X (Apple, Inc., Cupertino, Calif. US), and the client would be in the form of a software application that runs on the operating system. For purposes of this disclosure, the term “software” refers to a set of machine-readable instructions that, when executed by a machine, cause the machine to perform a defined series of tasks. Generally, software is encoded on a machine-readable medium, either magnetic (e.g., hard disk drive), optical (e.g., CD drive, DVD drive, etc.) or solid state (e.g., random access memory, read-only memory, USB drives, and solid state drives). Software may be compiled, interpreted, or translated from human-readable source code into executable code in any other manner, either prior to or during execution of the code. For example, a client may be implemented in a combination of the Visual Basic and C# programming languages. In some embodiments, the general-purpose computer may be a general-purpose computer with limited or defined capabilities, such as a smart phone or personal digital assistant. In other embodiments, the software that performs the client functions may be implemented as a part of a special purpose computer or integrated system, in which the software would be permanently stored on the special purpose computer for execution.

The machine on which the software that defines the client is executed is not critical to the invention, and although some advantageous embodiments of system 10 may involve a stand-alone software application running on a general purpose computer, as was described above, other embodiments may involve the software that performs the client functions being executed on a central server, such as server 12, or in part on a central server and in part on a machine local to an individual user. In yet other embodiments, the local machine may be a portable device, such as a laptop computer, notebook computer, cellular telephone, or so-called “smart” phone, like the BlackBerry family of handheld devices (Research in Motion, Waterloo, Ontario, Canada) and the Apple iPhone.

The software that performs the client functions need not run directly on an operating system, and there may be additional “layers” of software between the hardware and the client software. For example, client software could be adapted to run within a Web browser on a client machine. In that case, a central server, such as web server 32, could provide instructions, for example, in the form of a combination of HTML and JavaScript or a JAVA applet, that are retrieved and executed by a Web browser as part of an HTML, XML, or other markup language. In that case, the functionality of the clients 16, 18, 20, 22 may be divided in execution between the client machine and the server. Alternatively, instead of JAVA applets and scripted programs executed as part of a markup language page retrieved and loaded by a browser, a client 16, 18, 20, 22 may be implemented as a browser plug-in or other form of application that is installed on the client machine and runs within the browser software.

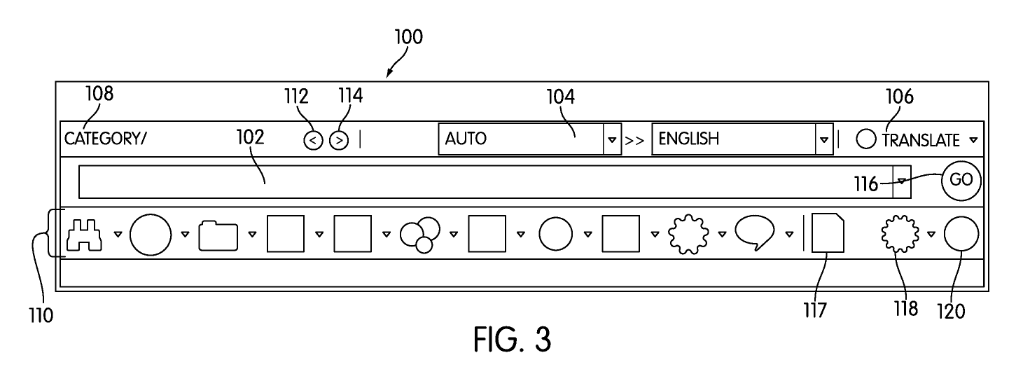

FIG. 3 is an illustration of one form of graphical user interface, generally indicated at 100, for a client 16, 18, 20, 22. In view of the above description, those of skill in the art will appreciate that graphical user interfaces such as interface 100 will look and function differently on different machines and with different operating systems and other software “beneath” them. Thus, although some aspects of the following description may assume that the graphical user interface 100 is that created by an application running, for example on Windows XP, the functions and tasks that are described may be readily implemented on any of the sorts of clients that are described above.

The graphical user interface 100 of FIG. 3 is a minimized interface that provides the user with a query field 102 in which queries can be entered, a set of translation controls 104 that define the intended language of the search and the language into which results are to be translated, a message menu 106 that provides the user with access to messages from the server 12 or from the operator of the system, and at least one set of category selection controls 108. The interface 100 allows the user to perform a “multi-search” or to search multiple sites in a number of different categories, including general web search, maps, user favorites, news, shopping, sports, entertainment, travel, medical, careers, and language translation.

The category selection controls 108 allow the user to direct the query in the query field 102 to one of the categories of search. In interface 100, a first set of category selection controls 108 allow the user to select the category by using a set of arrow buttons 112, 114 to cycle through the categories, with the current category displayed to the left of the arrow buttons 112, 114. When the user executes the query by pressing enter or selecting the button 116 to the right of the query field 102, a search will be performed using the default resource for that category. For example, a search done in the general web search category may default to being performed on one of the search engines, such as Google.

Typically, the interface 100 and underlying application will have a number of default behaviors, many of which may be modified by the user, by the server 12, or by either party. For example, when a query is executed using the minimal graphical user interface 100, the search may be executed on the default resource for the selected category, on all resources for that category, or on a particular resource that is not the default. The interface 100 may also default to a specific category, absent a specific user choice. The default resource in each category and the default category may be changed in some embodiments. By using such defaults, and by defaulting to searching a single resource, rather than multiple resources, the interface 100 provides a scaled down set of functions that may be used quickly when the user's needs are simple, without initiating a full multi-resource search. In some embodiments, the client 16, 18, 20, 22 may initiate communication with the server 12 at regular intervals, and the server 12 may set or re-set the client's defaults during these communications.

The category controls 110 also allow the user to select the category by means of a number of graphical buttons, one for each of the categories. Each of the buttons also provides a drop-down menu that allows a user to select a particular resource in the selected category on which to perform the search. Thus, using the category controls 110, a user can direct a search entered into the query field 102 to a particular resource 102.

In addition to those controls, an add resource control 116 allows the user to add a resource to the category lists. An options button 118 allows the user to change options, including, for example, the default resources and categories. Finally, an expand/contract button 120 allows the user to change the size of the interface 100 and to reveal additional features.

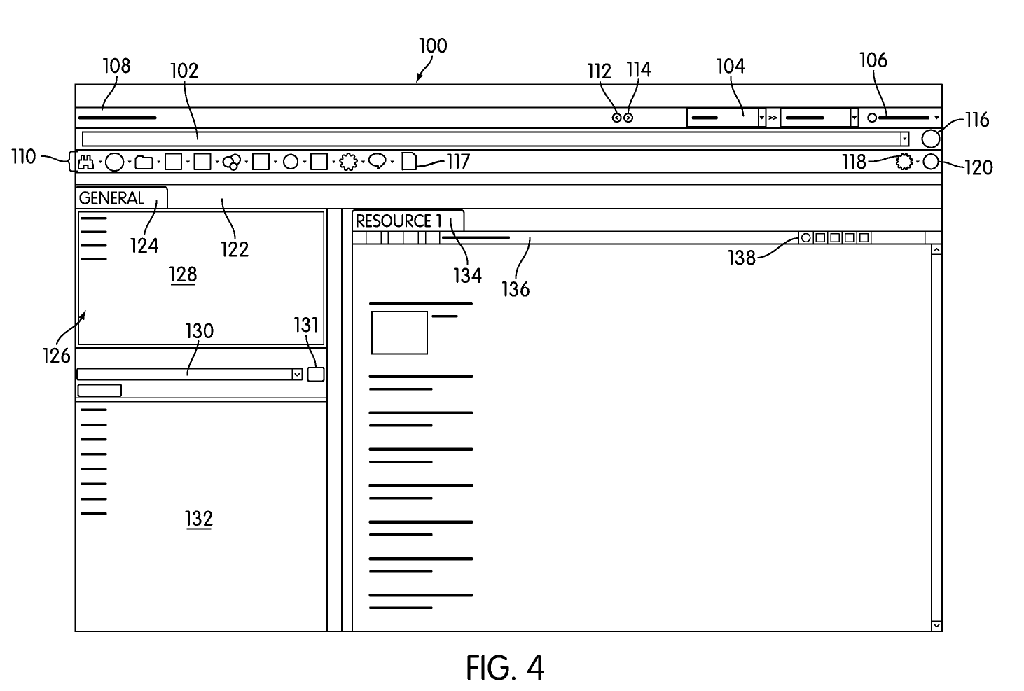

As was described above, the client application generally begins with a minimized interface, like interface 100, for the user's convenience, unless the user selects a different option. Either when the user executes a query or when the user presses the expand/contract button 120, a fuller interface is revealed. FIG. 4 is an illustration of a fuller or maximized version of interface 100.

In general, the interface 100 allows the user to perform multiple searches of resources in different categories, and multiple resources within each of those categories, and provides access to all of those results. The results are grouped or tiered, such that a user can move easily from search results in one category to search results in another. Additionally, search results are presented within a full browser interface, allowing the user to interact with the results fully, as if he or she was performing the search using a Web browser.

As can be seen in FIG. 4, the features described above with respect to FIG. 3 remain in the maximized version of the interface 100 shown in FIG. 4. Below the category controls 110, a first set of grouping elements, in this case a category tab bar 122, organizes the searches by category. In the view of FIG. 4, there is one tab 124 in the category tab bar 122. The tab 124 is a tab for a general search. As a convenience to the user, the tab 124 may also indicate the keywords used for the search.

Each of category tabs 124 contains two elements or sets of elements. First, as seen on the left side of FIG. 4, each category tab 124 contains a set of search controls 126 that allow a user to select one or multiple search resources from a given category, to enter search keywords, and to initiate searches. More specifically, the search controls 126 of FIG. 4 include a resource selection box 128 that includes a list of all of the resources that are defined in a given category. To perform a search, the user highlights one or more of the resources in the resource selection box 128, types one or more search keywords or terms into the query field 130, and depresses the execute button 130.

As will be described below in more detail, the actual resources that are listed in the resource selection box 128, and the order in which those resources are listed, may be set by the server 12 on a client-by-client, session-by-session, connection-by-connection, case-by-case, or other basis, and may be re-set or re-defined every time a client 16, 18, 20, 22 connects with the server 12.

Below the query field 130 is a favorites box 132 that lists specific, favorite resources of the user and allows the user to access those resources directly. The resources in the favorites box 132 may, for example, be resources that the user checks frequently, like e-mail, instant messaging, and social media sites (e.g., Twitter, Facebook, MySpace, etc.), or the resources may be those that provide generic information frequently desired or needed by the user, such as sports scores, weather, and travel information. If the ability to interface with social media sites is provided, the client 16, 18, 20, 22 may have a library or libraries that provide it with the information and protocols needed to communicate with those sites or resources.

Also contained by the category tab 124 are second sets of grouping elements, in this case browser tabs 134. Each browser tab has a complete set of browsing controls 136. The browsing controls 136 are those found in virtually any Web browser: a forward button, a back button, a stop button, a reload button, and a location bar, into which a user may type a full URL or alter the current URL. Therefore, when a browser tab 134 is open, the user may use it like a stand-alone Web browser. Specifically, the user may browse search results in any way known and, if desired, may type other URLs into the location bar and use a browser tab 134 to browse the Web in ways unrelated, or tangentially related, to the original search. A set of application buttons 138 allow the user to launch a number of applications, including various Web browsers.

Thus, in the illustrated embodiment, search results from each resource are displayed to the user in their entirety, although that need not be the case in all embodiments. Moreover, as will be described below in more detail the interface 100 advantageously uses a browser rendering engine, such that the search results are rendered and displayed as they would be in a browser, and as most of the resources intend them to be.

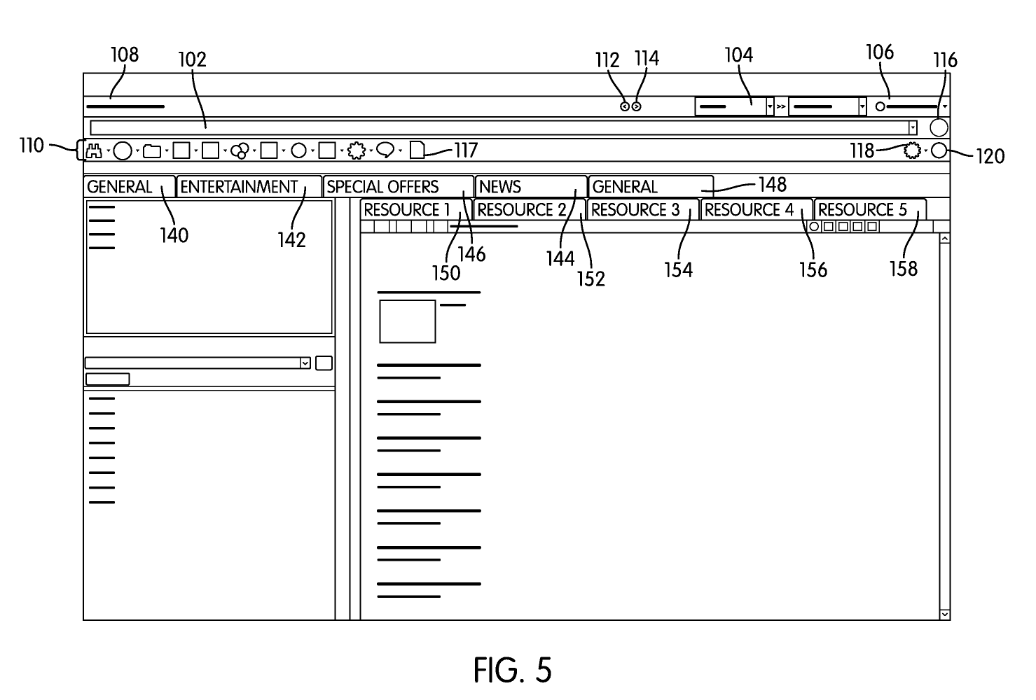

FIG. 5 is an illustration of the interface 100 after multiple searches have been initiated in multiple categories, most of those searches including multiple resources. Six category tabs are open on the category tab bar 122: a promotional tab 140 offers specific promotions from the operator of system 10, an entertainment tab 142 contains the results of an entertainment-related search, a second entertainment tab 144 contains the results of a separate entertainment-related search, a news tab 146 contains the results of a news search, and a general search tab 148 contains the results of a general (Web) search.

The general search tab 148 is the active tab. As is shown in FIG. 5, five browser tabs 150, 152, 154, 156, 158 are open, each one of which displays the search results for the same search query executed on a different resource.

The interface 100 may be implemented in substantially any way known in the art. However, if the interface 100 is part of a standalone client application, it may be helpful to develop the application using a known, industry-standard Web browser engine or kit. For example, Mozilla and its Gecko layout engine (The Mozilla Foundation, Mountain View, Calif.), Trident, Microsoft Corporation's layout engine, or WebKit, Apple, Inc.'s layout engine, may be used. The interface 100 may be built using, for example, XTML User Interface Language (XUL).

The use of an industry-standard Web browser engine ensures that search results are rendered and presented as they would be had the URL been accessed in a stand-alone browser.

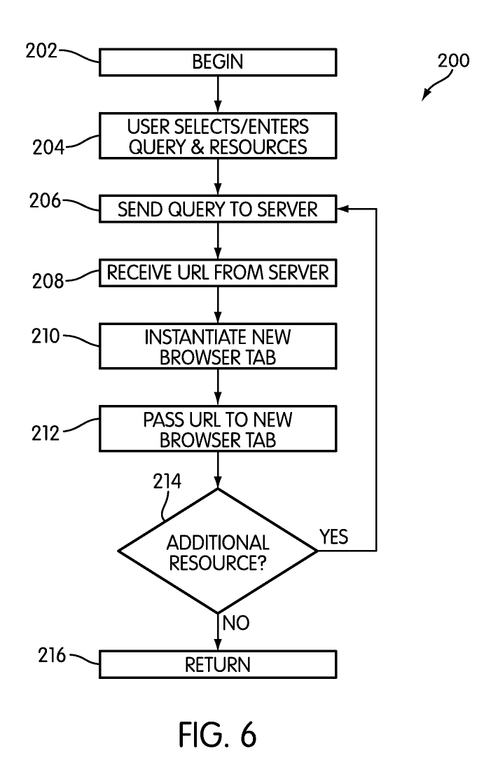

FIG. 6 is a flow diagram of a method, generally indicated at 200, for making queries and displaying query results using one of the clients 16, 18, 20, 22 in system 10. Method 200 of FIG. 6 is a counterpart to method 50 of FIG. 2 insofar as FIG. 6 details the tasks on the client side, while FIG. 2 details the corresponding tasks on the server side. Method 200 begins at 202 and continues at 204 when the user enters a query or keywords and selects resources for the search. With respect to interface 100, the user may enter a search in any of the search or query fields provided, and resources may be selected in any of the ways set forth above.

When a user depresses the appropriate button or hits the appropriate key to execute the search, the client 16, 18, 20, 22 sends the query to the server 12, as shown in task 206 of method 200. Generally, task 206 and the tasks that follow it are performed one-at-a-time, i.e., the client 16, 18, 20, 22 asks the server 12 for a URL for each one of the resources in serial fashion, as in query (1) set forth above. This is advantageous in that the results can easily be passed to and retrieved by individual browser tabs without any further operations. However, in some embodiments, a client 16, 18, 20, 22 may make a concatenated query that lists, in a single request to the server 12, all of the resources for which a URL is being requested. The results from the server 12 would then need to be de-concatenated before being passed to individual browser tabs.

In task 208 of method 200, after the query is sent to the server 12, the server 12 sends back to the requesting client a URL with the appropriate query language for the requested resource. A new browser tab is then instantiated or created in task 210 of method 200, and the URL sent by or retrieved from the server 12 is passed to that new browser tab in task 212. At that point, the search results for that one resource will be available in the browser tab.

As was noted above, the retrieval of search results is done serially in the illustrated embodiment, although it may also be done in parallel. Therefore, task 214 is a decision task, in which it is determined whether there are resources for which URLs must still be obtained. If so (task 214:YES), control of method 200 returns to task 206 and the process repeats for the next resource. If URLs for all selected resources have been obtained, method 200 returns at 216.

In addition to the tasks depicted in method 200, and as was described briefly above, the clients 16, 18, 20, 22, may have certain additional features. For example, a client 16, 18, 20, 22 may “save” a search, insofar as the category, resources, and search query may be stored by the client 16, 18, 20, 22 so that it can be repeated at some later point. The search may be saved or stored within the client 16, 18, 20, 22 itself, it may be saved within a “favorites” folder provided by the operating system, or it may be saved or stored in any other suitable location. Saved searches may be saved in the form of a collection or folder of URL files which will open in any browser or any other application compatible with them. These URL files can be e-mailed or shared in other ways with other users and on other machines. If a stored search is executed again, the client would perform method 200 and send the search query and resources to the server 12, so that the results of the search are fresh.

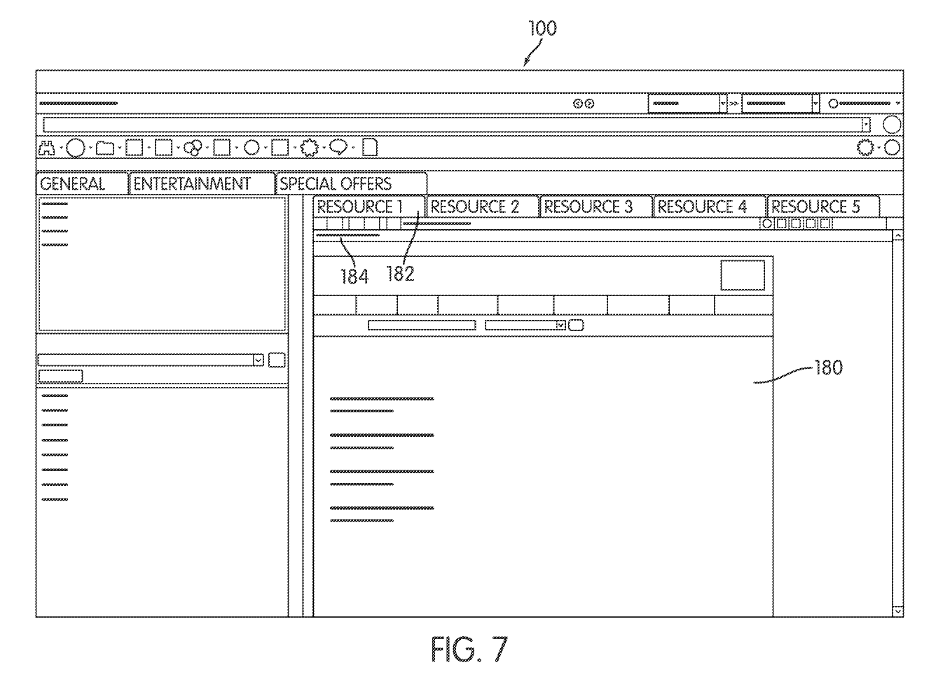

As was described above, using methods 50 and 200, the server 12 may provide the client 16, 18, 20, 22 with URLs that are modified to frame or otherwise insert coupons, messages, and other offers into Web sites. FIG. 7 is an illustration of the interface 100 with a Web site 180 displayed in a browser tab 182. Above the content of the site, a message frame 184 with invisible borders displays a message indicating that coupons and special offers are available for the site 180. If a user clicks within that frame 184, another window may open to reveal the details of those coupons or offers.

### Group- and Vendor-Specific Systems

As those of skill in the art will appreciate, systems, methods, and software according to embodiments of the invention have the ability to “drive” or direct traffic to particular resources, thus potentially increasing the revenues that those resources provide. In some embodiments, the operator of the system may drive traffic to a particular resource in exchange for some form of consideration.

Traffic may be driven to a particular resource in a variety of ways. For example, the server 12 may change the order or identity of the resources that are listed in the resource selection box 128 of interface 100, with the expectation that resources listed first in the resource selection box 128 will be accessed more frequently than resources that are listed farther down on the list. The server 12 may also add or delete resources from the resource selection box 128.

In addition to the above techniques, there is no requirement that the resources that are opened, or for which search URLs are provided to the clients, correspond exactly to those that the user has selected, e.g. in the resource selection box 128. In some embodiments, the server 12 may use a keyword matching, natural language processing, or other algorithm to interpret the type of search that the user is requesting and to locate other resources, including those not selected by the user, that may provide relevant search results. In one embodiment, when a search is initiated by a client, the server may examine the search terms, find additional resources matching the search terms, and return URLs for those additional resources, which are then retrieved by the clients. Alternatively, the server may direct a client to populate a resource selection box or list, such as resource selection box 128, with the additional sites, so that the user has the option of opening those resources but is not required to.

In some embodiments, specific versions of the client software may be prepared for particular groups, organizations, or associations, such that each user and client within the group has access to the resources that are most helpful for the types of searches performed by the members of the group. In group-specific versions of the client software, the resources that appear by default in resource selection lists may be tailored for the group, and may, in some cases, include resources internal to the group, e.g., corporate intranets, databases, and document collections. Additionally, the “favorites” section of the interface may provide access to social media resources (e.g., instant messaging) internal to the group. In group-specific embodiments, although each group may have its own central server, in many embodiments, a single server may serve clients in a plurality of different groups.

In other embodiments, particular vendors or resource providers may distribute group-specific versions of the client software to their clients. Those versions of the software may list resources that are dictated in whole or in part by the vendor distributing the software. As with other group-specific versions of the software, although each group may have its own central server, in many embodiments, a single server may serve clients in a plurality of different groups.

In addition to tailoring or selecting software features and available resources to meet the needs of specific groups and vendors, specific promotions and offers may be made available to members of particular groups.

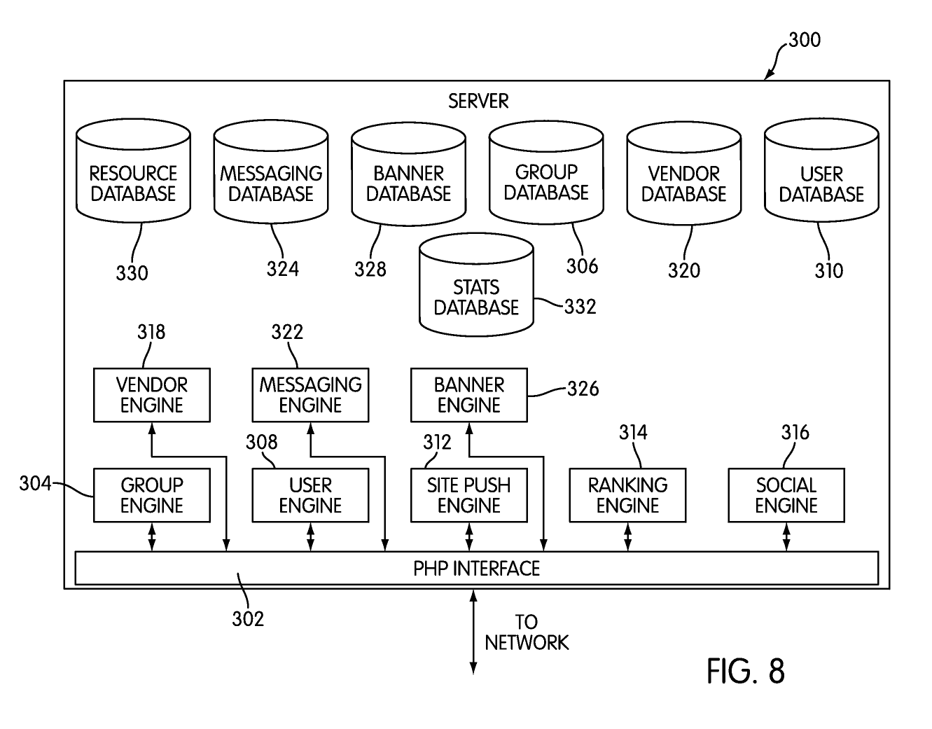

FIG. 8 is a functional illustration of a server, generally indicated at 300, that includes features used to manage vendor- and group-specific client software and allows the system to interface with a broader range of resources, including social media. In the following description of server 300, it should be assumed that server 300 is implemented in a system much like system 10, except that individual clients may belong to one or more identifiable groups.

Physically, on the hardware level, server 300 may be any type of conventional server, or any type of machine capable of implementing the described functions. The hardware executes Web server software, as described above with respect to system 10 and Web server 32. Functionally, a PHP interface 302 handles all queries from the network and provides basic functionality. A number of engines, modules of executable code that perform specific functions, are executed by the PHP interface as necessary to respond to particular queries or to perform particular functions. A number of databases, for example, SQL databases, are provided on the server 300 and are accessed by the various engines as necessary.

Of the engines present in server 300, the group engine 304 is responsible for tracking and determining which users are members of which groups, and which groups are associated with and/or permitted to access which particular resources. In performing its functions, the group engine may access the group database 306.

The user engine 308 is responsible for tracking and interpreting information and traits regarding individual users. If the server 300 provides instant messaging services, or other services, the user engine 308 may also be responsible for tracking which users particular users are permitted to contact. The user engine 308 accesses the user database 310 in performing its functions.

The site push engine 312 is responsible for evaluating a user's search query and finding other resources that the user may wish to search on, as was described above. In doing so, the site push engine 312 may use any number of the databases available to the server 300 and may evaluate the language of the search or search string, the previous searches requested by that particular user, similar searches requested by other users, the degree of similarity between different users, and any number of other factors. Once those other resources have been identified, the site push engine 312 forwards them to the client, as described above.

The ranking engine 314 is responsible for determining which resources appear in resource selection lists, and in what order, based on which resources are providing the operator of the system with consideration and/or compensation.

The social engine 316 provides the interface routines, protocols, and procedures necessary to allow the clients to interface directly or indirectly with social media sites and resources, so that users can post updates and otherwise interact with those resources from within a client 16, 18, 20, 22. Depending on the embodiment, there may be more than one social engine (e.g., one engine per resource), and to the extent that any of the social media sites or resources provides an application programming interface (API), the social engine 316 may use it.

The vendor engine 318 is responsible for coordinating vendor-specific information and vendor-customized versions of the client software. The vendor engine 318 may make use of the vendor database 320 to associate specific vendors with specific resources.

The messaging engine 322 is responsible for coordinating message traffic, e.g., instant message traffic, among users of the system. The messaging engine may comprise a message server, such as a Jabber server or a server based on the extensible messaging and presence protocol (XMPP), or an interface to an external message server. Information used to implement messaging services may be stored in the messaging database 324.

Finally, the banner engine 326 is responsible for providing “banners” and other indications that special promotions and other incentives are available for particular vendors. Information on which resources are associated with promotions may be stored in the banner database 328. Thus, the banner database 326 performs essentially the same functions as the promotional database 36 described above with respect to system 10.

Of the other databases shown as being a part of server 300 in FIG. 8, the resource database 330 performs essentially the same functions as the resource database 34 of server 12 in system 10, and the stats or statistics database 332 stores information relating to the usage of the server 300, including log information.

Server 300 may have any number of additional engines and databases, and may include other features. For example, in some embodiments, server 300 may also include a calendar engine that determines the current date and provides clients with promotions timed to that date.

The engines and databases shown as a part of server 300 are illustrated for purposes of explanation; two or more of the engines may cooperate, or multiple functions may be performed by a single engine.

While the invention has been described with respect to certain embodiments, the embodiments are intended to be exemplary, rather than limiting. Modifications and changes may be made within the scope of the invention, which is defined by the claims.

What is claimed is:

1. A multi-search system, comprising:
a server system including a site database, wherein the server system accepts search requests from one or more clients in first, generalized query formats, translates those search requests into specific resource locators for one or more resources by querying the site database and returns the specific resource locators to the one or more clients;
the one or more clients each having an interface with a search form that accepts search terms and generates the first, generalized query formats for the queries, transmits the first, generalized query formats to the server system through a communications network, and retrieves search results corresponding to the specific resource locators, the interface also having a first set of grouping elements that group search results by category and a second set of grouping elements that group search results by resource;
wherein the interface renders the search results using a browser engine.

2. The multi-search system of claim 1, wherein the first and second grouping elements comprise respective sets of tabs.

3. The multi-search system of claim 2, wherein each of the second set of tabs comprises the search form and a browser window.

4. The multi-search system of claim 1, wherein the interface provides browser functionality, allowing a user to follow links in the search results.

5. The multi-search system of claim 1, wherein the server system also includes a promotional database that stores promotions associated with certain search requests, wherein the server checks the promotional database after receiving the search request, and if a promotion associated with the search request exists, returns the specific resource locator indicating the promotion.

6. The multi-search system of claim 5, wherein the server system returns the specific resource locator indicating the promotion by assembling an alternate resource locator indicating a frame set including the resource and the promotion and returning the alternate resource locator as the specific resource locator.

7. The multi-search system of claim 5, wherein the server system returns the specific resource locator indicating the promotion by assembling an alternate resource locator in which code defining the resource is altered to include indicia of the promotion and returning the alternate resource locator as the specific resource locator.

8. The multi-search system of claim 1, wherein the communications network comprises the Internet.

9. The multi-search system of claim 1, wherein the server system comprises a Web server coupled to the site database.

10. The multi-search system of claim 1, wherein search results from each of the one or more resources are presented in their entirety.

11. The multi-search system of claim 1, wherein the one or more clients transmit and the server system accepts a plurality of search requests for the same search terms to be retrieved from different ones of the resources.

12. The multi-search system of claim 1, wherein each of the one or more clients comprises an application running on a computer.

13. A method for executing searches on a plurality of resources, comprising:
receiving a plurality of search requests in a respective first, general formats over a communications network from a first requester, the plurality of search requests involving the same search terms to be searched on a plurality of different resources;
translating the search requests from the first, general formats into a specific resource locators for the plurality of different resources;
returning the specific resource locators to a requesting client;
retrieving search results for the plurality of different resources using the specific resource locators; and
displaying the search results for the plurality of different resources in their entirety in a full browser interface, grouped by category and, separately, by resource.

14. The method of claim 13, further comprising searching for promotions associated with the plurality of different resources and, if a promotion exists, creating an altered resource locator including the promotion and returning the altered resource locator as the specific resource locator.

15. An interface for retrieving and presenting search results, the interface being implemented as a set of machine-readable instructions on a machine and comprising:
a search form allowing a user to select a search category and one or more search resources within the search category and to execute a search of the selected resources; and
a set of category grouping elements, each of the category grouping elements including one result grouping element per selected search resource, each result grouping element including a browser window that displays search results from a single one of the selected search resources in their entirety with full browser functionality;
wherein the interface forms queries in a first, generalized format for each of the selected resources and transmits the queries to a server, which returns specific resource locators for each of the selected resources.

16. The interface of claim 15, wherein the category grouping elements and result grouping elements comprise tabs.

17. The interface of claim 15, wherein the interface comprises a minimized version that includes a search form and instantiates the category and resource grouping elements after a search has been executed.

18. A method for searching, comprising:
allowing a user to select one or more categories and one or more resources and to enter one or more search terms to be searched on each of the one or more resources;
forming one or more queries in a generalized format, each of the one or more queries indicating at least the search terms and one of the one or more resources;
transmitting the queries in the generalized format to a server;
receiving from the server a specific resource locator for each of the resources that, when retrieved, will cause a search to be executed with the search terms;
retrieving the specific resource locator for each of the resources so as to obtain search results for each of the resources; and
displaying the search results in their entirety, grouped by category and by resource, in a full browser interface.

19. The method of claim 18, further comprising rendering the search results using a browser engine.

20. A search system, comprising:
one or more clients, each of the one or more clients comprising
a query routine that accepts a search query directed to a particular resource from a user and translates the query into a first, generalized format for transmission to a server, the particular resource being selected from a resource list determined, at least in part, by the server, and
a rendering engine that receives search results from the server and renders the results grouped by resource and by category;
the server comprising
an interface module that responds to queries sent to the search queries sent to the server and translates the first generalized format into a specific resource locator for the particular resource, and
a push engine that determines the resource list, and the order of resources within the resource list, for each of the one or more clients.

21. The system of claim 20, wherein the server further comprises a group engine that groups the one or more clients into particular groups and, in cooperation with the push engine, defines the resource list for the particular groups.

22. The system of claim 21, wherein the server further comprises a messaging engine that permits communication between the one or more clients that belong to distinct particular groups.

23. The system of claim 20, wherein the server further comprises a promotional engine that selectively provides promotions in connection with selected ones of the particular resources.

24. The system of claim 20, wherein ones of the one or more clients comprise client applications executed on respective computers.

25. The system of claim 20, wherein ones of the one or more clients comprise browser plug-ins executed within browser applications on respective computers.

26. The system of claim 20, wherein ones of the one or more clients comprise Web-based applications.
